(19) United States
(12) Patent Application Publication
(10) Pub. No.: US 2020/0184800 A1
(43) Pub. Date: Jun. 11, 2020

(54) Emergency Safety Monitoring System and Method

(71) Applicant: Monty Nixon, Woodbridge, VA (US)

(72) Inventor: Monty Nixon, Woodbridge, VA (US)

(21) Appl. No.: 16/793,402

(22) Filed: Feb. 18, 2020

Related U.S. Application Data
(63) Continuation-in-part of application No. 15/193,833, filed on Jun. 27, 2016.
(60) Provisional application No. 62/198,819, filed on Jul. 30, 2015.

(51) Int. Cl. G08B 25/01; G08B 7/06; G08B 25/10; H04M 1/725; H04W 76/50; G06F 3/16; G06F 1/16; H04W 4/90

(52) U.S. Cl. CPC G08B 25/016; G08B 7/06; G08B 25/10; H04M 1/72541; H04M 2250/10; G06F 3/167; G06F 1/163; H04W 4/90; H04W 76/50

(57) ABSTRACT

An emergency safety monitoring system. The emergency safety monitoring system device includes an actuator that sends a command. The command activates an audiovisual recorder that can capture audiovisual data on an electronic device. The command also causes a GPS receiver to record location information about the electronic device. After a predetermined amount of time, the captured audiovisual data and location information is communicated to a remote server, emergency personal, or preselected individuals. The command may cause the electronic device to send an emergency message, such as an SMS text message. Depending on whether the emergency safety and monitoring system is in the home mode or the away mode, the desired set of functions will be performed when the actuatable button is pressed.

### CROSS REFERENCE TO RELATED APPLICATIONS

This application claims the benefit of U.S. Non-Provisional patent application Ser. No. 15/193,833 filed on Jun. 27, 2016, which in turn claims the benefit of U.S. Provisional Application No. 62/198,819 filed on Jul. 30, 2015. The above identified patent application is herein incorporated by reference in its entirety to provide continuity of disclosure.

### BACKGROUND OF THE INVENTION

The present invention relates to an emergency safety monitoring system and method that provides multiple command user functions depending on the user's location, situation, circumstance, and threat level. The system and method also perform proactive countermeasures to provide an additional level of security for the user. More specifically, the present invention relates to a personal security platform system and methods that utilize an electronic device that is configured to send a variety of preselected commands by a handheld or a wearable device, wherein the electronic device comprises an audiovisual recording mechanism configured to capture audiovisual data and to also perform multiple preselected command functions setup by the user.

Home security, vehicle security, personal security, and mobile device ownership have risen over the years, whereas about 90% of American adults have adopted this consumer technology. Mobile devices have altered the way people communicate with each other, and assisted with the creation of a communication network that provides for almost instantaneous connection between persons. Thus, these mobile phone devices, home security systems, vehicle satellite locator security and other similar mobile devices have changed how many situations are handled, including emergency situations. However, during many different types of emergency situations it is often difficult or impossible for a person to reach out to others for assistance, or react proactively to thwart off an attacker or draw attention to your situation. The individual may not have access to a mobile phone or otherwise not have the ability to utilize the communication features of the electronic device, such as an audiovisual communication mechanism, car alarm, home interior lighting, or communication with vehicle satellite locator services. Further, if an individual is isolated, it can also be difficult to draw immediate attention to the situation, cause a distraction, and provide evidence or proof that a certain event actually occurred without substantial video or audio proof or witnesses.

Many electronic devices utilize a simple trigger mechanism that only send data and perform basic similar panic button features, however they only perform simple one size fits all functions. Typically, these electronic devices are activated and controlled by interacting with a touchscreen, where the audiovisual data is stored on electronic device, or by pressing a panic button. However, these electronic devices do not provide the user with the capability to setup and program multiple functions depending on the type of situation, location of the user, and the particular level of assistance needed, nor any capability to be proactive by initiating commands that initiate other systems that are connected to the same network or programmed into the device.

In light of the devices disclosed in the prior art, it is submitted that the present invention substantially diverges in design and operational elements from the prior art and consequently it is clear that there is a need in the art for an improvement to emergency safety monitoring systems and methods. In this regard the instant invention substantially fulfills these needs.

The idea for this invention was based upon my own actions whereas I would always have my spare car key next to my bed. If I heard any unusual sound I could easily activate the panic button on my car key which would sound my car alarm, and draw attention from my neighbors. The noise from my car alarm frightened the intruder as it made aware of his presence and no ways of him o deactivate the noise or control the situation. Years later, I purchased Bluetooth light switches that are linked to the wifi in my home. This gives me the opportunity to control my lights when I am home or away on vacation. I keep that controller next to my bed as well in the event I need to turn all lights in my home on with one single click of a button. This invention has both of these capabilities built in and offer complete home security protection, comfort, and deterrence by being proactive and not only pushing a panic button and waiting for a response. It puts the user back in control of any unwelcomed situation or circumstance. For children, the adult can ensure the safety of their children by creating home settings to thwart of potential pedophile activity, even if the suspect is a family member or guest in the home, giving the child peace of mind, security, comfort and protection while they are asleep.

The uniqueness of this invention is that it operates in different reactive modes, home and away, because the threats and circumstances encountered in different environments vary and so does our response to each threat or situation. A need for the user to react to a particular threat is not available and not offered in current technology. For example, the AWAY mode can be programmed to activate the user's motor vehicle alarm, and be configured to the vehicles ON STAR satellite system o quickly locate and disable the users vehicle if stolen. In the event of vehicle theft, the user can activate the device with 3 clicks on the activation button which will perform the actions preselected by the user.

In the home mode, the device will automatically switch to the setting profile created for home. It will connect to the wireless internet network in the home and also be in control of any Bluetooth lighting and/or household systems that are on the same home wireless internet network.

Furthermore, the present invention provides a limitless need for its use by children, adults, field reps, elderly, college students, homeowners and renters, vehicle owners, business owners, etc. The programmable settings and options available are setup based on the type of user and the users desired parameters of use. Spider Band features a unique set of very useful user ready command prompts which are adaptive and easy to configure.

### SUMMARY OF THE INVENTION

In view of the foregoing disadvantages inherent in the known types of safety systems and methods now present in the prior art, the present invention provides an emergency safety monitoring system wherein the same can be utilized for providing convenience for the user when providing a security reaction to a triggered event.

The present system, in some embodiments, comprises a wearable device. The wearable device has a global positioning transponder integrated therein. Also, the wearable device includes a wireless transceiver embedded as well. The wearable device is configured to transmit a command to an electronic device via the wireless transceiver.

The electronic device comprises an audiovisual recorder, a memory unit, a signal transmitter, a global positioning system receiver, a processor and a logic stored in the memory unit. The electronic device is in operable connection with a motor vehicle security system and a home security system.

The logic, when executed by the processor, causes the electronic device to perform a method of receiving the command from the wearable device, determining whether the electronic device is in a home ode or an away mode, performing a first set of functions if the electronic device is in the home mode and performing a second set of functions if the electronic device is in the away mode.

The first set of functions is different from the second set of functions. Both the first set of functions and the second set of functions selected from the group of functions including: capturing a video feed via the video recorder once the command is received, capturing an audio feed via the sound recorder once the command is received, recording a location of the wearable device, transmitting the video feed, the audio feed and the location of the wearable device to a remote storage location, engaging the motor vehicle security system; and engaging the home security system.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a block diagram of an embodiment of the emergency safety monitoring system.

FIG. 2 shows an operational flowchart of an embodiment of the emergency safety monitoring system in the home mode and in the away mode.

FIG. 3 shows a perspective view of an embodiment of the emergency safety monitoring system.

FIG. 4 shows a perspective view of an embodiment of the emergency safety monitoring system.

### DETAILED DESCRIPTION OF THE INVENTION

Reference is made herein to the attached drawings. Like reference numerals are used throughout the drawings to depict like or similar elements of the emergency safety monitoring system. The figures are intended for representative purposes only and should not be considered to be limiting in any respect.

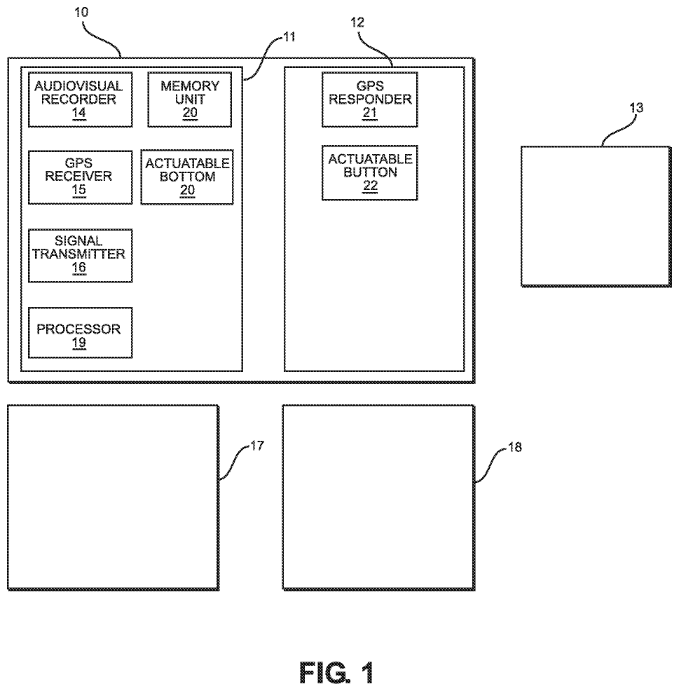

Referring now to FIG. 1, there is shown a block diagram of an embodiment of the emergency safety monitoring system. In operation, the emergency safety monitoring system enables a user to communicate information to remote locations in the event that assistance is required, and documents audiovisual information that is captured and recorded. Furthermore, the emergency safety monitoring system includes preprogrammed user features that can be activated by the user depending on a specific situation or location.

In some embodiments, the emergency safety monitoring system 10 comprises an electronic device 11. The electronic device 11 may be a smartphone, tablet, wireless network router, or similar device. The electronic device 11 may be in operable connection with a wearable device 12 and a remote storage location 13. The electronic device 11 includes an audiovisual recorder 14 and a global positioning system (GPS) receiver 15. The audiovisual recorder 14 may comprise any necessary component for capturing audiovisual data, such as a camera and a microphone. The GPS receiver 15 is configured to receive a GPS signal from a satellite, such that the position of the electronic device 11 may be recorded and transmitted. The electronic device 11 may, in some embodiments, further comprise a signal transmitter 16. The signal transmitter 16 may be programmed, such that a signal is emitted to any device paired with the electronic device 11. For example, the signal transmitter 16 may be configured to transmit a signal to a motor vehicle 17 or a home security system 18.

The electronic device 11 is further configured to transmit the recorded audiovisual data and GPS position to the remote storage location 13. The remote storage location 13 includes any type of communication networks, any server apparatus, program application, or cloud network. The remote storage device 13 may include any type of non-transitory computer-readable medium or other storage device. Some non-limiting examples of non-transitory computer-readable media include CDs, DVDS, BLU-RAY, flash memory and hard disc drives. This further includes storage on a plurality of remote servers or cloud storage. Upon receiving the relevant data, the remote storage location 13 stores the information such that it remains accessible to the user or other authorized persons. In one embodiment, the remote storage location 13 may encrypt the data, allowing access only to authorized personnel, as well as by emergency personnel such as the police and fire department.

The electronic device 11 comprises a processor 19. The processor 19 is configured to enact a set of actions once a command is received. The command is generated when the actuator of the electronic device 11 or the wearable device 12 is actuated (via a wireless transmitter in the wearable device 12). The electronic device 11 may be powered via an integral power source, such as a rechargeable battery disposed therein, or by an external power source that is in electronic communication with the electronic device 11.

The wearable device 12 may be any handheld or wearable item. For example, the wearable device 12 can be attached to a key ring, a purse, a beltloop, a backpack or a shoelace. Ideally, the wearable device 12 will be discrete is shape and configuration, such that the wearable device 12 can maintain its inconspicuous nature by not standing out. By remaining concealed, the wearable device 12 allows for the emergency safety monitoring system 10. Additionally, the size and convenience of the wearable device 12 allows for the user to keep the device within close range while sleeping, making it easier to reach and react to the situation without any hesitation. The wearable device 12 comprises a GPS transponder 21, such that the GPS location of the wearable device 12 can be recorded. Furthermore, the wearable device 12 comprises an actuator, such that the wearable device 12 can send a command to the electronic device 11.

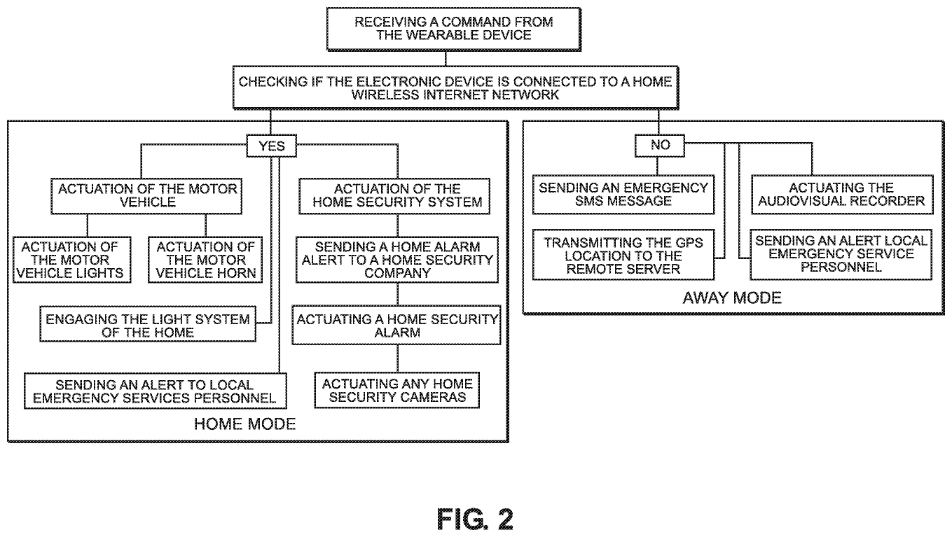

Referring now to FIG. 2, there is shown an operational flowchart of an embodiment of the emergency safety monitoring system in the home mode and in the away mode. In some embodiments, the electronic device may be modular, such that. the user may set the mode of operation of the emergency safety monitoring system to a home mode, an away mode or any desired mode of operation. Each mode of operation is linked to a set of functions that are performed once a command is received by the electronic device. In some embodiments, the emergency safety monitoring system is automatically modular. For example, when the emergency safety monitoring system connects to a wireless network that is registered as the user's home wireless internet network, the emergency safety monitoring system will be switched to the home mode.

In the illustrated embodiment, when in the home mode, the electronic device performs the method of, preliminarily, receiving a command from the wearable device or the electronic device. Once the command is received and it is determined that the electronic device is in the home mode, a first series of functions are performed. In some embodiment, the series of functions are predetermined by the user. In the illustrated embodiment of the home mode, the series of functions comprises actuation of the motor vehicle. The motor vehicle is configured to actuate its alarm system once the command is received. When the motor vehicle alarm system is actuated, the motor vehicle lights and horn can be actuated, alerting individuals in the auditory area. Additionally, in the illustrated embodiment of the home mode, the series of functions comprises actuation of the home security system. As such, when the home security system is actuated, a home alarm alert is sent to a home security company and any home security cameras will be actuated, capturing audiovisual data of the home.

Furthermore, in the illustrated embodiment of the home mode, the command is also configured to engage the light system of a home. As such, any lights connected to the home wireless network will be turned on. Finally, in the illustrated embodiment of the home system, an alert is sent to local emergency services personnel and to any preselected emergency contacts. A database of contacts is stored on the memory unit of the electronic device, such that the preselected emergency contacts can be selected therefrom. The electronic device can be configured to send a message to the preselected emergency contacts by any preferred means, such as by SMS text message.

In the away mode, once the command is received from the wearable device or electronic device, a second set of functions may be engaged. In some embodiments, the series of commands for the away mode are engaged at any time when the electronic device is connected to a cellular network and not a home wireless internet network. For example, if the electronic device is connected to a guest wireless internet network or is not connected to any wireless internet network. In the illustrated embodiment, once the command is received from the wearable device or electronic device and is not connected to a home wireless internet network, such as sending an emergency SMS message, actuating the audiovisual recorder of the electronic device, transmitting the GPS location to the remote server, and second an alert to local emergency services personnel.

In other embodiments, the series of commands can be personalized or modular, such that specific functions can be performed in specific situations. For example, the user may program a personal threat setting, a robbery/abduction setting or a vehicle theft setting. Notably, for the vehicle theft setting, the electronic device could be programmed to engage the vehicle security system, sounding an alarm or rendering the vehicle inoperable. Additionally, the

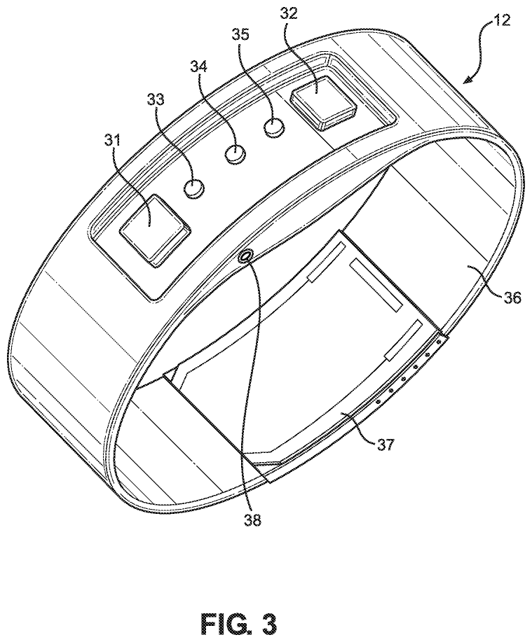

Referring now to FIG. 3, there is shown a perspective view of an embodiment of the emergency safety monitoring system. In the illustrated embodiment, the wearable device 12 is a wristband adapted to be secured about a user's wrist. The wearable device 12 comprises an activation button 31. The activation button 31 is configured to activate the command action functions of the electronic device. Furthermore, in the illustrated embodiment, the wearable device 12 comprises a power button 32. The power button 32 is configured to turn the wearable device 12 on and off. Alternatively, the illustrated device could be the electronic device 11.

Furthermore, in the illustrated embodiment, the wearable device 12 comprises a recording indicator 33, a wireless connection indicator 34 and a power indicator 35. The recording indicator 33 is configured to display a light when a recording by the audiovisual recorder is in progress. The wireless connection indicator 34 is configured to display a light when the wearable device 12 is in operable connection with the electronic device. The power indicator 35 is configured to indicate when the wearable device 12 is low on, or out of power. Additionally, in the illustrated embodiment, the band 36 of the wearable device 12 is an adjustable band formed via a pair of opposing straps. Specifically, the band 36 comprises an adjuster 37, such that the circumference provided by the band 36 can be expanded or reduced to better fit the wrist of the user.

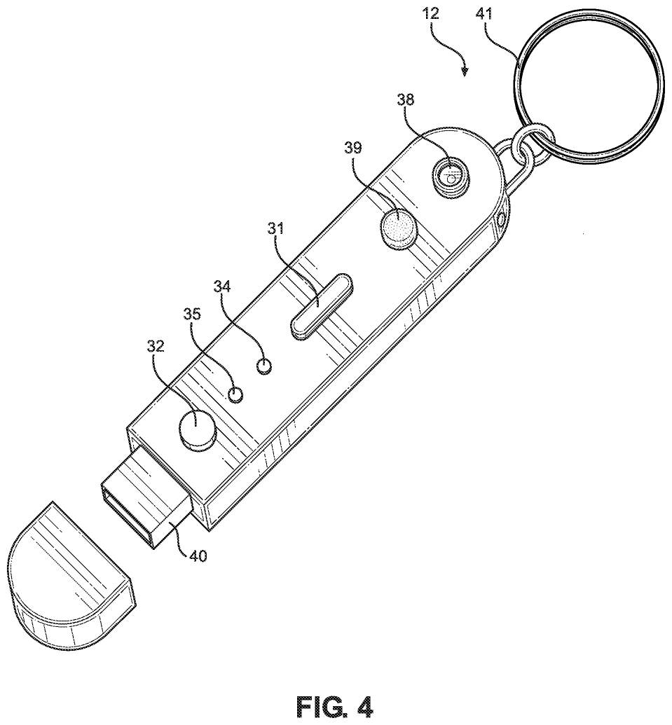

Referring now to FIG. 4, there is shown a perspective view of an embodiment of the emergency safety monitoring system. In the illustrated embodiment of the wearable device 12 (or the electronic device 11), the wearable device 12 is an elongated member that comprises a camera 38 and a microphone 39. The illustrated wearable device 12 further includes an activation button 31, a power button 32 as well a power indicator 35 and a wireless connection indicator 34. The wearable device 12, in the illustrated embodiment, further comprises a charging connector 40, such as a USB connector, with which the wearable device 12 can be charged. The wearable device 12, as shown, also includes a connector ring 41, such that the wearable device 12 can be attached to a key or similar device.

In some embodiments, the wearable device comprises a fail-safe mechanism. As such, actuation of the wearable device can be deactivated within a predetermined time threshold by engaging the fail-safe mechanism. For example, in a situation where the wearable device is mistakenly activated, the user could revoke the command, such that it will not perform the series of functions. This would be useful, as to avoid unnecessary emergency notifications to emergency services personnel.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An emergency safety monitoring system, comprising:
an actuator configured to transmit a command to an electronic device via a transceiver;
the electronic device comprising an audiovisual recorder, a memory unit, a signal transmitter, a global positioning system receiver, a processor and a logic stored in the memory unit;
the electronic device in operable connection with a motor vehicle security system;
the electronic device in operable connection with a home security system;
the logic, when executed by the processor, causing the electronic device to perform a method comprising:
receiving the command from the actuator;
determining whether the electronic device is in a home mode or an away mode;
performing a first set of functions if the electronic device is in the home mode;
performing a second set of functions if the electronic device is in the away mode;
the first set of functions being different from the second set of functions;
the first set of functions and the second set of functions selected from the group consisting of:
capturing a video feed via the video recorder once the command is received;
capturing an audio feed via the sound recorder once the command is received;
recording a location of the wearable device;
transmitting the video feed, the audio feed and the location of the wearable device to a remote storage location;
engaging the motor vehicle security system; and
engaging the home security system.

2) The emergency safety monitoring system of claim 1, wherein the motor vehicle security system comprises a vehicle alarm, a vehicle light and a vehicle global positioning transponder.

3) The emergency safety monitoring system of claim 1, wherein the home security system comprises a home alarm, a home light and a home camera.

4) The emergency safety monitoring system of claim 1, wherein the audiovisual data stored on the remote memory storage device is encrypted.

5) The emergency safety monitoring system of claim 1, wherein the audiovisual data is stored on the electronic device.

6) The emergency safety monitoring system of claim 1, wherein the electronic device further comprises a voice activatable module, wherein activation of the voice activatable module causes a command to be communicated to the electronic device.

7) The emergency safety monitoring system of claim 1, wherein a database of contacts is stored on the memory unit of the electronic device.

8) The emergency safety monitoring system of claim 1, wherein the electronic device further comprises a timer, the timer configured to communicate the audiovisual data to the remote memory storage after a certain amount of time.

9) The emergency safety monitoring system of claim 1, wherein the electronic device is configured to operate over both a cellular network and a local area network.

10) The emergency safety monitoring system of claim 1, wherein the vehicle security system is configured to render the vehicle temporarily inoperable.

11) The emergency safety monitoring system of claim 1, wherein the actuator comprises a fail-safe mechanism, such that actuation of the actuator can be deactivated within a predetermined time threshold.

12) The emergency safety monitoring system of claim 1, wherein the remote storage location is a cloud-based storage system.

13) The emergency safety monitoring system of claim 1, wherein the electronic device is a device selected from the group consisting of a mobile phone, a laptop computer and a desktop computer.

14) The emergency safety monitoring system of claim 1, further comprising a wearable device comprising the actuator, a global positioning transponder, and a wireless transceiver, wherein the actuator is configured to transmit a command to an electronic device via the wireless transceiver.

15) The emergency safety monitoring system of claim 14, wherein the wearable device is a bracelet comprising a face with a pair of straps extending outwardly therefrom forming a band, the face comprising an actuation button, a power button, a wireless connection indicator, a recording indicator and a power indicator.

16) The emergency safety monitoring system of claim 15, wherein the band is an adjustable band.

17) The emergency safety monitoring system of claim 14, wherein the wearable device is a key fob, the key fob being elongated in configuration and comprising a charging interface, a camera, a microphone, an actuation button, a wireless connection indicator, a recording indicator and a power indicator.
